(19) United States
(12) Patent Application Publication
(10) Pub. No.: US 2022/0067592 A1
(43) Pub. Date: Mar. 3, 2022

(54) INFORMATION PROVIDING SYSTEM, INFORMATION PROVIDING DEVICE, AND COMPUTER READABLE RECORDING MEDIUM

(71) Applicant: TOYOTA JIDOSHA KABUSHIKI KAISHA, Toyota-shi (JP)

(72) Inventor: Hiroshi MAJIMA, Tokyo (JP)

(73) Assignee: TOYOTA JIDOSHA KABUSHIKI KAISHA, Toyota-shi (JP)

(21) Appl. No.: 17/366,703

(22) Filed: Jul. 2, 2021

(30) Foreign Application Priority Data
Aug. 27, 2020 (JP) 2020-143637

(51) Int. Cl. G06Q 10/02

(52) U.S. Cl. CPC G06Q 10/02

(57) ABSTRACT

An information providing system includes: a server including a first processor configured to output predetermined information to a terminal of a user; and a terminal including a second processor configured to cause a display to display information acquired from the server, wherein the first processor is configured to predict a transportation unit to be used by the user, and output information regarding a usage method for the predicted transportation unit to the terminal, and the second processor is configured to cause the display to display the information regarding the usage method for the transportation unit.

The present application claims priority to and incorporates by reference the entire contents of Japanese Patent Application No. 2020-143637 filed in Japan on Aug. 27, 2020.

### BACKGROUND

The present disclosure relates to an information providing system, an information providing device, and a computer readable recording medium.

A ticket across a plurality of transportation operators (railroad, subway, bus, ship, and the like) (hereinafter referred to as an excursion pass) is known (see, for example, JP 2020-071107 A).

### SUMMARY

When using an excursion pass, a user may feel inconvenient because a usage method (for example, boarding/alighting method, boarding/alighting position, boarding stand, fare, payment method, and the like) differs depending on the transportation unit provided by the transportation operator.

There is a need for an information providing system, an information providing device, and a computer readable recording medium that improve the convenience when an excursion pass is used.

According to one aspect of the present disclosure, there is provided an information providing system including: a server including a first processor configured to output predetermined information to a terminal of a user; and a terminal including a second processor configured to cause a display to display information acquired from the server, wherein the first processor is configured to predict a transportation unit to be used by the user, and output information regarding a usage method for the predicted transportation unit to the terminal, and the second processor is configured to cause the display to display the information regarding the usage method for the transportation unit.

### BRIEF DESCRIPTION OF THE DRAWINGS

FIG. 1 is a schematic diagram illustrating an overall configuration of an information providing system according to an embodiment;

FIG. 2 is a block diagram illustrating details of each component of the information providing system according to the embodiment;

FIG. 3 is a diagram illustrating an example of a route search condition input screen to be displayed on a terminal in the information providing system according to the embodiment;

FIG. 4 is a diagram illustrating an example of a route search result display screen to be displayed on a terminal in the information providing system according to the embodiment;

FIG. 5 is a diagram illustrating an example of an electronic ticket corresponding to an excursion pass displayed on a terminal in the information providing system according to the embodiment; and

FIG. 6 is a flowchart illustrating an example of an information providing method executed by the information providing system according to the embodiment.

### DETAILED DESCRIPTION

The information providing device according to the embodiment of the present disclosure will be described with reference to the drawings. Note that the components in the embodiment described below include those that may be easily replaced by those skilled in the art or those that are substantially the same.

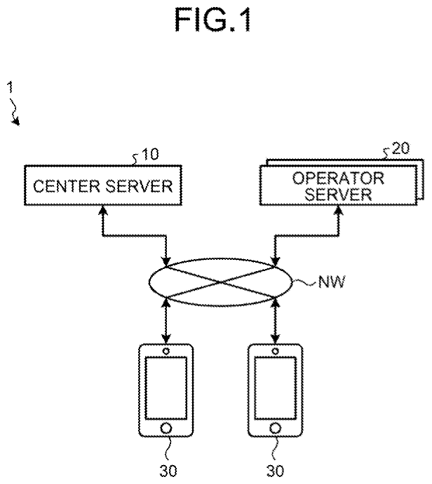

The information providing system including the information providing device according to the embodiment will be described with reference to FIGS. 1 to 5. As illustrated in FIG. 1, an information providing system 1 includes a center server 10, a plurality of operator servers 20, and a plurality of terminals 30. The information providing device according to the embodiment is realized by the function of the center server 10 of the information providing system 1. The center server 10, the operator servers 20, and the terminals 30 all have a communication function, and are configured to be able to communicate with each other through a network NW. This network NW includes, for example, the Internet, a mobile phone network, and the like.

The center server 10 is for providing predetermined information to the terminal 30 owned by the user. Specifically, the center server 10 performs multimodal route search from the starting point to the destination by combining one or more of a plurality of transportation units such as automobiles, walking, bicycles, and public transportation facilities, and provides the route search result to the terminal 30. Further, the center server 10 is realized by a workstation or a general-purpose computer such as a personal computer.

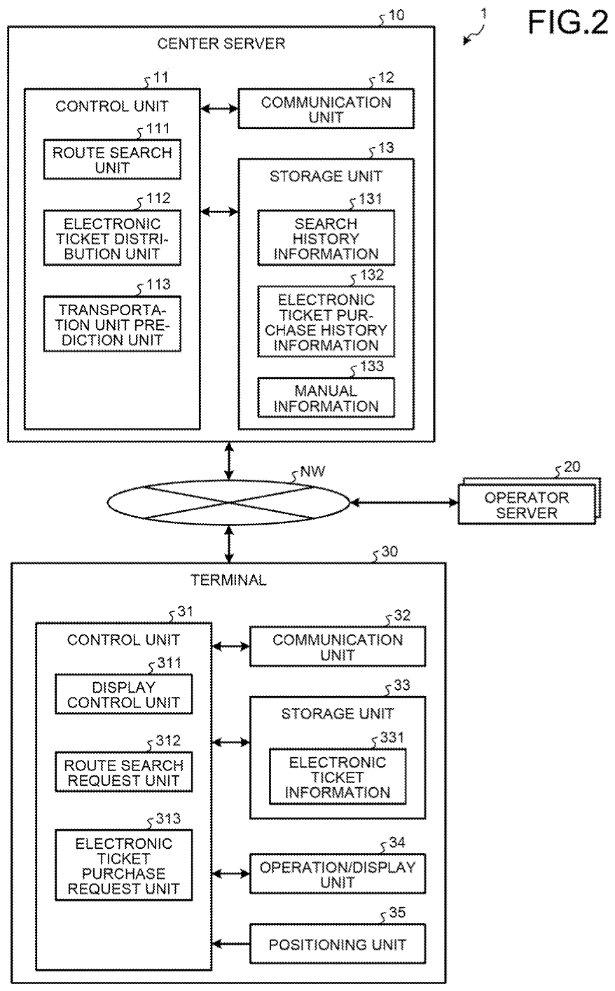

As illustrated in FIG. 2, the center server 10 includes a control unit (first processor) 11, a communication unit 12, and a storage unit 13. Specifically, the control unit 11 includes a processor including a central processing unit (CPU), a digital signal processor (DSP), and a field-programmable gate array (FPGA), and a memory (main storage unit) including a random access memory (RAM) and a read only memory (ROM).

The control unit 11 loads a program stored in the storage unit 13 into a work area of the main storage unit and executes it, and controls each constituent unit or the like through the execution of the program to realize a function that meets a predetermined purpose. The control unit 11 functions as a route search unit 111, an electronic ticket distribution unit 112, and a transportation unit prediction unit 113 through the execution of the program stored in the storage unit 13.

The route search unit 111 performs a multimodal route search by combining a plurality of transportation units by communicating with the plurality of operator servers 20 based on a route search request acquired from the terminal 30. Then, the route search unit 111 stores the result of the route search in the storage unit 13 as search history information 131.

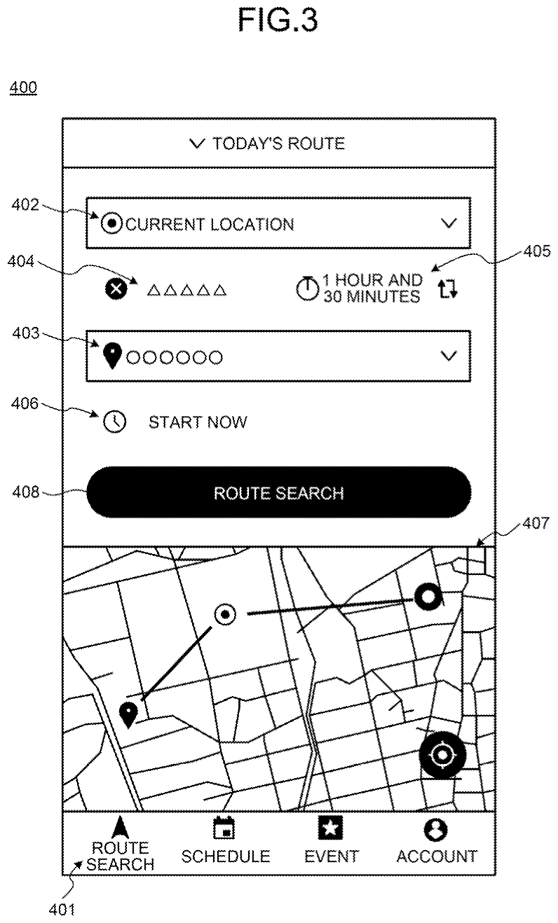

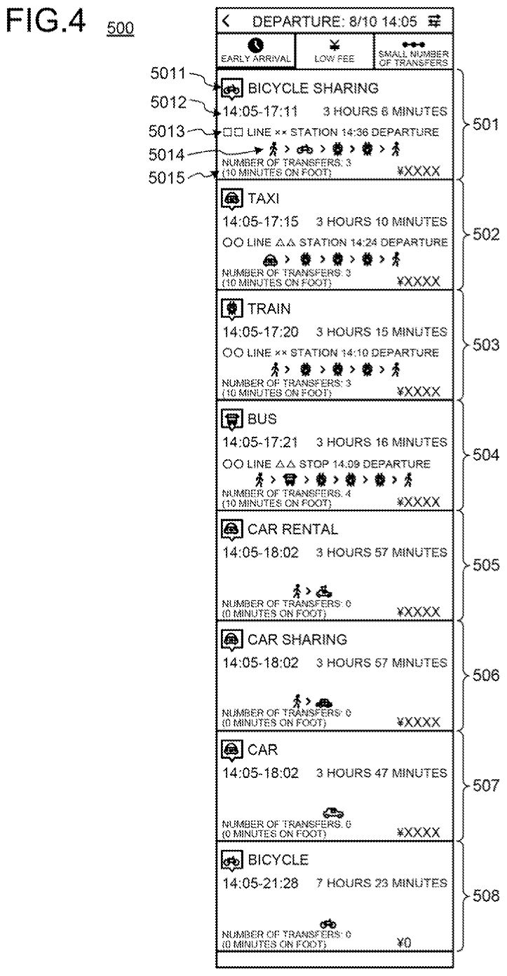

Here, FIG. 3 illustrates an example of a route search condition input screen 400 displayed on an operation/display unit 34 of the terminal 30 when the route search unit 111 performs route search. Further, FIG. 4 illustrates an example of a route search result display screen 500 displayed on the operation/display unit 34 of the terminal 30 when the route search unit 111 performs route search.

The input screen 400 of FIG. 3 is displayed on the operation/display unit 34 when, for example, in a route search application installed on the terminal 30, a route search button 401 of the menu at the bottom in the drawing is pressed (for example, a touch operation on the corresponding position of the operation/display unit 34). The input screen 400 includes a starting point box 402, a destination box 403, a waypoint box 404, a stay time setting menu 405, a departure time setting menu 406, a map display area 407, and a route search execution button 408.

The starting point box 402 is for setting the starting point in the multimodal route search. In the starting point box 402, for example, the current position of the terminal 30 detected by a positioning unit 35 of the terminal 30 is set as a default setting.

The destination box 403 is for setting the starting point in the multimodal route search. The waypoint box 404 is for setting a waypoint in the multimodal route search. The stay time setting menu 405 is for setting the stay time at a waypoint in the multimodal route search. The departure time setting menu 406 is for setting the departure time from the starting point in the multimodal route search.

In the map display area 407, a map image of the area including the starting point, the destination, and the waypoint set in the starting point box 402, the destination box 403, and the waypoint box 404 is displayed. The route search execution button 408 is for causing the route search unit 111 to execute the multimodal route search according to the contents set in the starting point box 402, the destination box 403, the waypoint box 404, the stay time setting menu 405, and the departure time setting menu 406. When the route search execution button 408 is pressed by the user, a route search request is transmitted from the terminal 30 to the center server 10. Then, the route search unit 111 performs route search based on the route search request.

On the input screen 400 of FIG. 3, when the route search execution button 408 is pressed by the user and then the route search result is sent from the route search unit 111 to the terminal 30, the screen transitions to the display screen 500 illustrated in FIG. 4. Route candidate display areas 501 to 508 corresponding to a plurality of route candidates are displayed on the display screen 500.

The route candidate display areas 501 to 508 include, for example, a display field 5011 for displaying typical transportation units included in the route candidates, a display field 5012 for displaying the transportation time, a display field 5013 for displaying a boarding station and an alighting station of public transportation facilities, a display field 5014 for displaying the symbol mark of each transportation unit, a display field 5015 for displaying the number of times of transfer and the walking time, and the like.

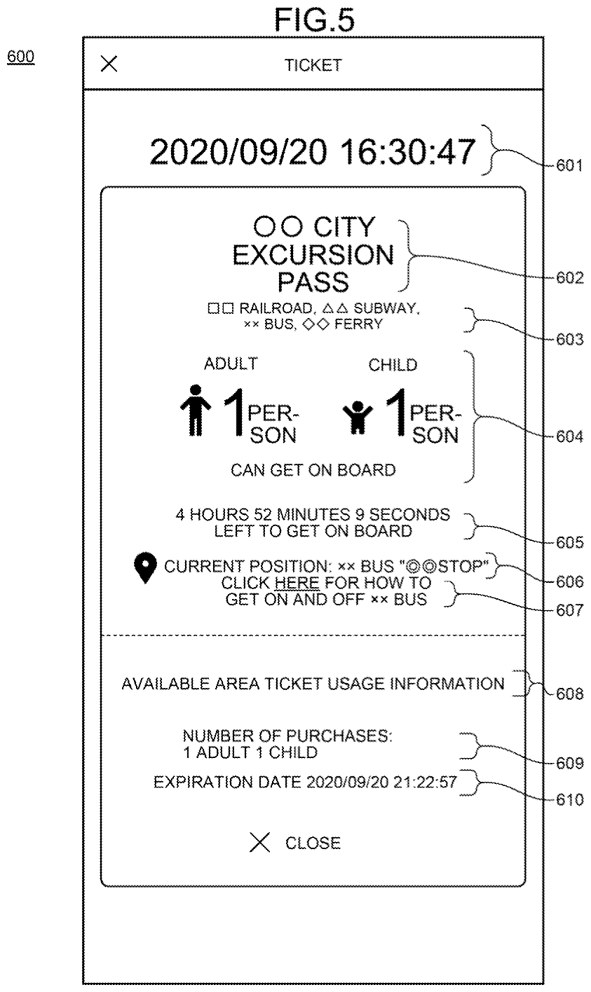

The electronic ticket distribution unit 112 distributes an electronic ticket to the terminal 30. This “electronic ticket” is an electronic version of a paper ticket issued by the transportation operator. Further, the electronic ticket in the present embodiment assumes an excursion pass that allows free use of a plurality of transportation facilities (railroad, subway, bus, ship, and the like) within a predetermined period and within a predetermined area (see FIG. 5).

Specifically, when the electronic ticket distribution unit 112 acquires an electronic ticket purchase request from the terminal 30, the electronic ticket distribution unit 112 generates electronic ticket information based on the purchase request. Then, the electronic ticket distribution unit 112 transmits the generated electronic ticket information to the terminal 30. Further, the electronic ticket distribution unit 112 stores the information regarding the sold electronic ticket in the storage unit 13 as electronic ticket purchase history information 132.

Note that payment of the electronic ticket may be performed, for example, in the information providing system 1 or may be performed through an external payment system (for example, a financial institution). When the payment of the electronic ticket is performed in the information providing system 1, the payment is performed at the same time when the electronic ticket is purchased through an electronic ticket application installed on the terminal 30. Then, when the electronic ticket purchase request is transmitted from the terminal 30 to the center server 10, electronic ticket payment completion information is also transmitted at the same time. Further, when the payment of the electronic ticket is performed through the external payment system, the electronic ticket payment completion information is transmitted from the external payment system to the center server 10 separately from the electronic ticket purchase request transmitted from the terminal 30.

The transportation unit prediction unit 113 predicts a transportation unit to be used by the user, and transmits information regarding a usage method for the predicted transportation unit to the terminal 30. The transportation unit prediction unit 113 may predict the transportation unit to be used by the user, for example, based on the user's position information acquired from the terminal 30. For example, when the user is located near a bus stop, the transportation unit prediction unit 113 predicts that the transportation unit to be used by the user is a “bus”. Then, the transportation unit prediction unit 113 transmits information regarding the usage method for this bus within manual information 133 stored in the storage unit 13 to the terminal 30. By using the user's current position information in this way, it is possible to easily predict the transportation unit to be used by the user.

Further, the transportation unit prediction unit 113 may predict the transportation unit to be used by the user based on the result of the route search performed based on a request from the terminal 30. For example, when the result of the route search by the route search unit 111 (see FIG. 4) includes a route using a bus, the transportation unit prediction unit 113 predicts that the transportation unit to be used by the user is a “bus”. Then, the transportation unit prediction unit 113 transmits information regarding the usage method for this bus within manual information 133 stored in the storage unit 13 to the terminal 30. In this way, by using the result of the user's route search, it is possible to easily predict the transportation unit to be used by the user.

Further, the transportation unit prediction unit 113 may predict the transportation unit to be used by the user based on both the result of the route search and the position information of the user. For example, when the result of the route search by the route search unit 111 (see FIG. 4) includes a route using a railroad and a bus, and when the user is located near a bus stop, the transportation unit prediction unit 113 predicts that the transportation unit to be used by the user is a “bus”. Then, the transportation unit prediction unit 113 transmits information regarding the usage method for this bus within manual information 133 stored in the storage unit 13 to the terminal 30. By using the user's current position information and the result of the route search in this way, it is possible to accurately predict the transportation unit to be used by the user.

The communication unit 12 includes, for example, a local area network (LAN) interface board, a wireless communication circuit for wireless communication, and the like. The communication unit 12 is connected to the network NW such as the Internet, which is a public communication network. Then, the communication unit 12 communicates with the operator server 20 and the terminal 30 by connecting to the network NW.

The storage unit 13 includes a recording medium such as an erasable programmable ROM (EPROM), a hard disk drive (HDD), and a removable medium. Examples of the removable medium include disc recording media such as universal serial bus (USB) memory, compact disc (CD), digital versatile disc (DVD), and Blu-ray (registered trademark) disc (BD). The storage unit 13 may store an operating system (OS), various programs, various tables, various databases, and the like.

The storage unit 13 stores the search history information 131, the electronic ticket purchase history information 132, and the manual information 133.

The search history information 131 is information indicating the history of the route search performed by the route search unit 111. The search history information 131 includes, for example, a route search condition, a route search result, and the like for each user (terminal 30).

The electronic ticket purchase history information 132 includes, for example, information such as the user who purchased the electronic ticket, the purchase date and time of the electronic ticket by the user, the number of purchases, the purchase amount, the expiration date, and the ticket type (adult or child).

The manual information 133 is information regarding a usage method for each transportation unit used in the multimodal route search. The manual information 133 includes, for example, a boarding/alighting method, a boarding/alighting position, a boarding stand, a fare, a payment method, an electronic ticket presentation method, and the like for each transportation unit.

The operator server 20 is a server managed by an operator that provides a transportation unit used for multimodal route search. This center server 10 is realized by a workstation or a general-purpose computer such as a personal computer.

The servers that constitute the operator server 20 include, for example, route bus-related servers, railroad-related servers, highway bus-related servers, aviation-related servers, ship-related servers, taxi-related servers, ride-sharing-related servers, car-sharing-related servers, rental car-related servers, and bicycle-sharing-related servers.

The route bus-related server is operated by a route bus operating company or the like, and provides information regarding the operation of the route bus (for example, timetable, operation status including delays, current position of each vehicle, and the like) to the center server 10. Further, the railroad-related server is operated by a railroad operating company or the like, and provides information regarding the operation of the railroad (for example, timetable, operation status including delays, availability of each train that may be reserved, and the like) to the center server 10. Further, the highway bus-related server is operated by a highway bus operating company or the like, and provides information regarding the operation of the highway bus (for example, timetable, operation status including delays, availability of each vehicle, and the like) to the center server 10. Further, the aviation-related server is operated by an airplane operating company or the like, and provides information regarding the operation of the airplane (for example, timetable, operation status including delays, availability of each flight, and the like) to the center server 10.

Further, the ship-related server is operated by a ship operating company or the like, and provides information regarding the operation of the ship (for example, timetable, operation status including delays, availability of each service that may be reserved, and the like) to the center server 10. Further, the taxi-related server is operated by a taxi service providing company or the like, and provides various information regarding the service of the taxi (for example, position information of each vehicle, operation status including vacant/occupied, and the like) to the center server 10. Further, the ride-sharing-related server is operated by a ride-sharing service providing company or the like, and provides various information regarding the service of ride sharing (for example, current position of each vehicle operated by ride sharing, whether a vehicle may be allocated, and the like) to the center server 10. Further, the car-sharing-related server is operated by a car-sharing service providing company or the like, and provides various information regarding the service of car sharing (for example, the number of parking spaces at each station that provides shared cars, the number of currently available cars, the number of returnable cars, and the like) to the center server 10.

Further, the rental car-related server is operated by a rental car service providing company or the like, and provides various information regarding the service of rental car (for example, the vehicle types that may be prepared at each business office that rents a car, the number of currently preparable cars of each car type at each business office, and the like) to the center server 10. Further, the bicycle-sharing-related server is operated by a bicycle-sharing service providing company or the like, and provides various information regarding the service of bicycle sharing (for example, the number of bicycles that may be provided at each of a plurality of bicycle ports that provides shared bicycles, the number of currently available bicycles, and the like) to the center server 10. In this way, the center server 10 performs the multimodal route search based on the information provided from each server constituting the operator server 20.

The terminal 30 is for displaying the information acquired from the center server 10 on the operation/display unit 34. Specifically, the terminal 30 performs a route search request to the center server 10 based on a user operation, and displays a route search result acquired from the center server 10. Further, the terminal 30 displays the information of an electronic ticket acquired in advance. The terminal 30 is realized by, for example, a smartphone, a mobile phone, a tablet terminal, a wearable computer, or the like owned by the user.

As illustrated in FIG. 2, the terminal 30 includes a control unit (second processor) 31, a communication unit 32, a storage unit 33, the operation/display unit (display) 34, and the positioning unit 35. The control unit 31 functions as a display control unit 311, a route search request unit 312, and an electronic ticket purchase request unit 313 through the execution of the program stored in the storage unit 33.

The display control unit 311 controls the display on the operation/display unit 34. The display control unit 311 causes the operation/display unit 34 to display, for example, the route search condition input screen 400 (see FIG. 3), the route search result display screen 500 (see FIG. 5), and an electronic ticket face screen 600 (see FIG. 5).

The electronic ticket face screen 600 illustrated in FIG. 5 includes an area 601 for displaying the current time, an area 602 for displaying the title of the electronic ticket, an area 603 for displaying the transportation operator for which the electronic ticket may be used, an area 604 for displaying the ticket type (adult or child) of the electronic ticket, areas 605 and 610 for displaying the expiration date of the electronic ticket, an area 606 for displaying the user's current position, an area 607 for displaying a method of using a transportation unit to be used, an area 608 for displaying the area where the electronic ticket may be used and usage guidance, and an area 609 for displaying the number of purchases.

Here, the display control unit 311 causes the operation/display unit 34 to display information regarding the usage method for the transportation unit predicted by the transportation unit prediction unit 113 of the center server 10. At that time, the display control unit 311 causes the operation/display unit 34 to display information regarding the usage method for the transportation unit, for example, when the user uses the transportation unit predicted by the center server 10. Note that when the user uses a plurality of transportation units according to the result of the multimodal route search, the display control unit 311 causes the operation/display unit 34 to display the information regarding the usage method for the transportation unit each tine each usage unit is used.

The display control unit 311 may cause the operation/display unit 34 to display the information regarding the usage method for the transportation unit, for example, at a timing when the user moves to the vicinity of the transportation base (for example, a bus stop) of the transportation unit predicted by the transportation unit prediction unit 113. In this case, the display control unit 311 determines whether or not the user has moved to the vicinity of the transportation base based on the position information detected by the positioning unit 35. By using the user's position information in this way, it is possible to display the information regarding the usage method for the transportation unit at a timing required by the user, and the convenience of the user is improved.

Further, the display control unit 311 may cause the operation/display unit 34 to display the information regarding the transportation unit predicted by the transportation unit prediction unit 113 at the timing obtained based on the result of the route search in the route search unit 111 of the center server 10. For example, it is assumed that the result of the route search is the route departing from the bus stop at “14:09” as illustrated in a route candidate display area 504 of FIG. 5. In this case, the display control unit 311 causes the operation/display unit 34 to display the information regarding the usage method for the bus at the timing of “14:09”. By using the result of the route search in this way, it is possible to display the information regarding the usage method for the transportation unit at a timing required by the user, and the convenience of the user is improved.

Further, when the information regarding the usage method for the transportation unit is acquired from the transportation unit prediction unit 113, the display control unit 311 may display a notification to that effect on the operation/display unit 34 as a push notification and may cause the operation/display unit 34 to display the information regarding the usage method for the transportation unit when the push notification is selected by the user. By giving a push notification in advance when the information regarding the usage method for the transportation unit is acquired from the center server 10 in this way, it is possible to display the information regarding the usage method for the transportation unit at a timing required by the user, and the convenience of the user is improved.

Further, the display control unit 311 may display the information regarding the usage method for the transportation unit acquired from the transportation unit prediction unit 113 on the face of the electronic ticket. In this case, the display control unit 311 may display a link to the information regarding the usage method for the transportation unit as illustrated in the area 607 of the face screen 600 of FIG. 5 or may directly display the information regarding the usage method for the transportation unit on the face screen 600. By displaying the information regarding the usage method for the transportation unit on the face of the electronic ticket in this way, it is possible to check the usage method for the transportation unit when the user presents the electronic ticket.

The route search request unit 312 transmits a route search request to the center server 10 in response to a user operation. Specifically, when the route search execution button 408 on the route search condition input screen 400 (see FIG. 3) is pressed by the user, the route search request unit 312 transmits a route search request based on the input content to the center server 10.

The electronic ticket purchase request unit 313 transmits the electronic ticket purchase request to the center server 10 in response to a user operation. Then, when the electronic ticket purchase request unit 313 acquires the electronic ticket information from the center server 10, the electronic ticket purchase request unit 313 stores the information as electronic ticket information 331 in the storage unit 33.

The communication unit 32 communicates with the center server 10 by wireless communication via the network NW. The storage unit 33 stores the electronic ticket information 331.

The electronic ticket information 331 is information regarding the electronic ticket purchased by the user and includes, for example, information such as the purchase date and time of the electronic ticket, the number of purchases, the purchase amount, the expiration date, and the ticket type (adult or child). Note that the storage unit 33 stores, for example, in addition to the electronic ticket information 331, application programs (route search application and electronic ticket application) for realizing the display control unit 311, the route search request unit 312, and the electronic ticket purchase request unit 313.

The operation/display unit 34 includes, for example, a touch panel display or the like, and has an input function for receiving an operation by a user's finger or a pen, and a display function for displaying various information based on the control of the display control unit 311. The operation/display unit 34 displays the route search condition input screen 400 (see FIG. 3), the route search result display screen 500 (see FIG. 4), the electronic ticket information (see FIG. 5), an electronic ticket purchase screen, and the like based on the control of the display control unit 311

The positioning unit 35 receives radio waves from a global positioning system (GPS) satellite and detects the information regarding the current position of the terminal 30 (hereinafter referred to as “position information”). The method for detecting the position information is not limited to the method using GPS satellites, and may use, for example, a method combining light detection and ranging or laser imaging detection and ranging (LiDAR) and a three-dimensional digital map, or the like. The positioning unit 35 transmits (outputs) the detected position information to the control unit 31.

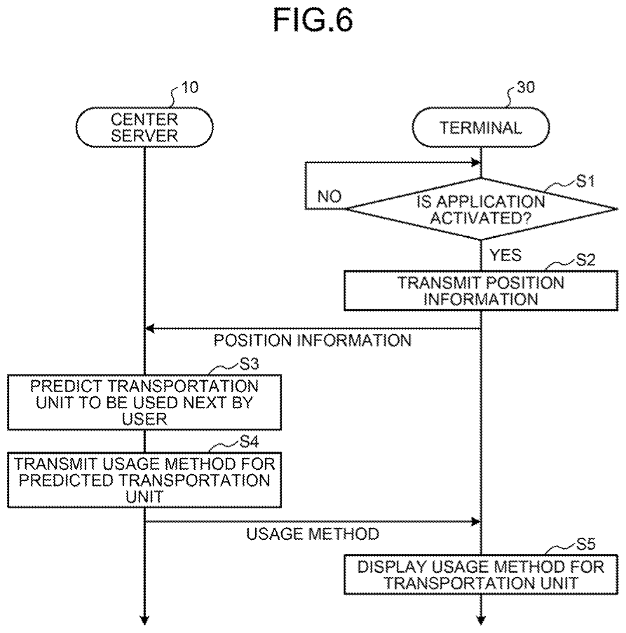

An example of the processing procedure of the information providing method executed by the information providing system 1 according to the embodiment will be described with reference to FIG. 6. In the drawing, an example of the case is described in which the transportation unit to be used by the user is predicted based on the user's position information acquired from the terminal 30.

First, the display control unit 311 of the terminal 30 determines whether or not the electronic ticket application is activated (Step S1). When it is determined that the electronic ticket application has not been activated (No in Step S1), the display control unit 311 returns to Step S1. On the other hand, when it is determined that the electronic ticket application has been activated (Yes in Step S1), the display control unit 311 transmits the user's position information detected by the positioning unit 35 to the center server 10 (Step S2).

Subsequently, the transportation unit prediction unit 113 of the center server 10 predicts a transportation unit to be used next by the user based on the user's position information (Step S3). Subsequently, the transportation unit prediction unit 113 transmits information regarding the usage method for the predicted transportation unit to the terminal 30 (Step S4). Subsequently, the display control unit 311 causes the operation/display unit 34 to display the usage method for the transportation unit (Step S5). Thus, the present processing is completed.

As described above, with the information providing system, the information providing device, and the information providing program according to the embodiment, it is possible to know the usage method in advance when using the transportation unit, and the convenience of the user is improved.

For example, with the information providing system, the information providing device, and the information providing program according to the embodiment, the prediction of the transportation unit used next by the user is performed on the center server 10 side (see FIG. 6), but the prediction of the transportation unit used next by the user may be performed on the terminal 30 side. Thus, the processing load on the center server 10 side may be reduced.

According to the present disclosure, the convenience of the user is improved because a usage method may be known in advance when the transportation unit is used.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system comprising:
a server comprising a first processor configured to output predetermined information to a terminal of a user; and
a terminal comprising a second processor configured to cause a display to display information acquired from the server, wherein
the first processor is configured to
predict a transportation unit to be used by the user, and
output information regarding a usage method for the predicted transportation unit to the terminal, and
the second processor is configured to cause the display to display the information regarding the usage method for the transportation unit.

2. The information providing system according to claim 1, wherein the first processor is configured to predict the transportation unit to be used by the user based on position information of the user acquired from the terminal.

3. The information providing system according to claim 1, wherein the first processor is configured to:
perform route search according to a preset transportation unit based on a request from the terminal; and
predict the transportation unit to be used by the user based on a result of the route search.

4. The information providing system according to claim 1, wherein the first processor is configured to:
perform route search according to a preset transportation unit based on a request from the terminal; and
predict the transportation unit to be used by the user based on a result of the route search and position information of the user acquired from the terminal.

5. The information providing system according to claim 1, wherein the second processor is configured to cause the display to display the information regarding the usage method for the transportation unit when the user uses the transportation unit predicted by the server.

6. The information providing system according to claim 1, wherein the second processor is configured to:
cause, when the information regarding the usage method for the transportation unit is acquired from the server, the display to display a notification to that effect; and
cause the display to display the information regarding the usage method for the transportation unit when the notification is selected by the user.

7. The information providing system according to claim 1, wherein the second processor is configured to:
cause the display to display an electronic ticket corresponding to an excursion pass that may use a plurality of transportation units; and
cause the information regarding the usage method for the transportation unit to be displayed on a face of the electronic ticket.

8. An information providing device comprising
a processor configured to output predetermined information to a terminal of a user, wherein
the processor is configured to:
predict a transportation unit to be used by the user; and
output information regarding a usage method for the predicted transportation unit to the terminal.

9. The information providing device according to claim 8, wherein the processor is configured to predict the transportation unit to be used by the user based on position information of the user acquired from the terminal.

10. The information providing device according to claim 8, wherein the processor is configured to:
perform route search according to a preset transportation unit based on a request from the terminal; and
predict the transportation unit to be used by the user based on a result of the route search.

11. The information providing device according to claim 8, wherein the processor is configured to:
perform route search according to a preset transportation unit based on a request from the terminal; and
predict the transportation unit to be used by the user based on a result of the route search and position information of the user acquired from the terminal.

12. A non-transitory computer-readable recording medium on which an executable program is recorded, the program causing a processor of a computer to execute:
outputting predetermined information to a terminal of a user;
predicting a transportation unit to be used by the user; and
outputting information regarding a usage method for the predicted transportation unit to the terminal.

13. The non-transitory computer-readable recording medium according to claim 12, wherein the program causes the processor to execute predicting the transportation unit to be used by the user based on position information of the user acquired from the terminal.

14. The non-transitory computer-readable recording medium according to claim 12, wherein the program causes the processor to execute:
performing route search according to a preset transportation unit based on a request from the terminal; and
predicting the transportation unit to be used by the user based on a result of the route search.

15. The non-transitory computer-readable recording medium according to claim 12, wherein the program causes the processor to execute:
performing route search according to a preset transportation unit based on a request from the terminal; and
predicting the transportation unit to be used by the user based on a result of the route search and position information of the user acquired from the terminal.
